(19) United States
(12) Patent Application Publication
(10) Pub. No.: US 2022/0241895 A1
(43) Pub. Date: Aug. 4, 2022

(54) SHIELDING GAS FOR LASER WELDING OF ALUMINUM AND ALUMINUM ALLOYS AND METHOD AND APPARATUS FOR USE THEREOF

(71) Applicants: Junjie Ma, Getzville, NY (US); Keith G. Pierce, East Amherst, NY (US)

(72) Inventors: Junjie Ma, Getzville, NY (US); Keith G. Pierce, East Amherst, NY (US)

(21) Appl. No.: 17/162,214

(22) Filed: Jan. 29, 2021

(51) Int. Cl. B23K 26/14; B23K 26/21; B23K 26/32

(52) U.S. Cl. CPC B23K 26/14; B23K 2103/10; B23K 26/32; B23K 26/21

(57) ABSTRACT

A shielding gas, apparatus, and method are provided for laser welding workpieces comprising aluminum or aluminum alloy. The shielding gas includes argon (Ar); and active gas components in a range of 0.5% to 3% by volume of the shielding gas. The active gas components include a combination of oxygen (O₂) and at least one of nitrous oxide (N₂O) and nitrogen (N₂).

### FIELD OF THE INVENTION

The present invention relates generally to an improved shielding gas for fiber laser welding of aluminum and aluminum alloys that reduces defects and improves surface appearance and roughness.

### BACKGROUND OF THE INVENTION

Laser beam welding is a process in which a focused laser beam is used as a heat source to join pieces of metal. The focused laser beam has a high power density that allows for high speed welding, deep penetration, and a narrow heat affected zone (HAZ). There are two distinct modes of laser welding; namely, conduction and keyhole welding. When the laser beam intensity is less than 10⁹ W/m², the laser beam irradiated on the workpiece surface is partially reflected and partially absorbed, which is referred to as Fresnel absorption. This absorption is affected by the wavelength of the laser and the thermal properties of the materials to be welded.

The laser energy absorbed on the surface of the workpiece is transported into the depth of material mainly by heat conduction and fluid convection of the melted material. This process is known as conduction mode welding. In conduction mode welding, the molten pool is shallow and the ratio of the weld depth-to-width is low. The molten steel evaporates when the laser beam intensity reaches 10⁹ W/m². When the laser beam intensity is increased around the range of 10¹⁰˜10¹¹ W/m², the recoil pressure of the metal vapor pushes the molten metal down and aside, generating a deep capillary called the keyhole. The metal vapor generated in the keyhole is ionized and forms a plasma or plume inside or above the keyhole. In a stable keyhole mode laser welding process, the keyhole remains open because of the dynamic balance between the liquid metal surface tension and the pressure of the metal vapor and laser-induced plasma.

A trend in the automotive industry is to replace steel as a material of construction with aluminum alloys. Another trend is that the amount of welded aluminum in cars has increased for each model as a replacement of riveting or other joining methods. The need for flawless painted automotive bodies is driving more stringent requirements for the surface quality of laser welded aluminum joints.

Current industrial welding processes utilizing pure inert shielding gases, such as argon, do not provide satisfactory results for all these characteristics when used to shield laser conduction welding aluminum or aluminum alloy containing work pieces.

When using argon as shielding gas for laser conduction welding of aluminum, it is common to have welds with defects that can cause a significant amount of the welded components to be rejected. Some of the common defects observed are skips or holes in the weld. These defects are often not correctable with additional processing, and the defective welded parts must be scrapped. Other common defects include rough weld surfaces which lead to unsatisfactory appearing parts after painting. Although these types of defects can be corrected, these defects require additional processing (e.g., post weld grinding), which increases cost of the part.

Accordingly, a need exists for an improved shielding gas composition that offer improved bead weld appearance, better wetting, and deeper weld penetration when compared to conventional shielding gases comprised of inert gases without active gas additives.

### SUMMARY OF THE INVENTION

The present invention is designed to address at least the problems and/or disadvantages described above and to provide at least the advantages described below.

An aspect of the present invention is to provide an improved shielding gas mixture (i.e., a combination of active gases and inert gases) for laser welding and method for use thereof, which reduce discontinuity defects (i.e., skips and holes) in finished welds.

Another aspect of the present invention is to provide an improved shielding gas for laser welding and a method and apparatus for use thereof, which improve surface appearance and decrease roughness on a finished aluminum weld.

Another aspect of the present invention is to provide an improved shielding gas for laser welding and a method and apparatus for use thereof, which improve welding penetration.

Another aspect of the present invention is to provide an improved shielding gas for laser welding and a method and apparatus for use thereof, which reduce the number of defects, effectively reducing scrap rates or required rework.

Another aspect of the present invention is to provide an improved shielding gas for laser welding and a method and apparatus for use thereof, which allow for higher welding speeds, thus improving productivity.

In accordance with an aspect of the present invention, a shielding gas is provided for laser welding workpieces comprising aluminum or aluminum alloy. The shielding gas includes argon (Ar); and active gas components in a range of 0.5% to 3% by volume of the shielding gas. The active gas components include a combination of oxygen (O₂) and at least one of nitrous oxide (N₂O) and nitrogen (N₂).

In accordance with another aspect of the present invention, a method is provided for laser welding workpieces including aluminum or aluminum alloy. The method includes activating the laser for a weld; and providing a shielding gas including argon (Ar) and active gas components to the weld. The active gas components are in a range of 0.5% to 3% by volume of the shielding gas, and the active gas components include a combination of oxygen (O₂) and at least one of nitrous oxide (N₂O) and nitrogen (N₂).

In accordance with another aspect of the present invention, an apparatus is provided for laser welding workpieces including aluminum or aluminum alloy. The apparatus includes a laser configured to apply a laser beam to a weld; and a shielding gas delivery system configured to provide a shielding gas including argon (Ar) and active gas components to the weld. The active gas components are in a range of 0.5% to 3% by volume of the shielding gas, and the active gas components include a combination of oxygen (O₂) and at least one of nitrous oxide (N₂O) and nitrogen (N₂).

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1A illustrates a basic structure of an apparatus for laser welding aluminum according to an embodiment of the present invention;

FIG. 1B illustrates a basic structure of an apparatus for laser welding aluminum according to an embodiment of the present invention;

FIG. 2 illustrates a flare bevel joint configuration and an overhead view a weld surface thereof, according to an embodiment of the present invention;

FIG. 3 illustrates comparisons of flare bevel joint welds of aluminum alloy 6061 using a shielding gas consisting only of Ar and a shielding gas mixture, according to an embodiment of the present invention;

FIG. 4 illustrates comparisons of flare bevel joint welds of aluminum alloy 3003 using a shielding gas consisting only of Ar and a shielding gas mixture, according to an embodiment of the present invention;

FIG. 5 illustrates comparisons of flare bevel joint welds of aluminum alloy 5052 using a shielding gas consisting only of Ar and a shielding gas mixture, according to an embodiment of the present invention;

FIG. 6 illustrates a comparison of bead on plate weld cross-sections using a shielding gas consisting only of Ar and a shielding gas mixture, according to an embodiment of the present invention; and

FIG. 7 illustrates a comparison of flare bevel weld cross-sections using a shielding gas consisting only of Ar and a shielding gas mixture of Ar and (N₂O+O₂) or (N₂+O₂), according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

According to an embodiment of the present invention, an improved shielding gas is provided for laser welding and method for use thereof, which reduce discontinuity defects (i.e., skips and holes) in finished welds. The improved shielding gas is a combination of active gases and inert gases. The active portion of the mixture may be a combination of two or more gas components. The first active gas component may be oxygen (O₂), and the second component of the active portion may one of nitrous oxide (N₂O), nitrogen (N₂), carbon dioxide (CO₂), carbon monoxide (CO), nitric oxide (NO), or combinations of these components. The first active gas component may be in the range of 0.1% to 2.9%, while the second active gas component may be in the range of 0.1% to 2.9%.

Additionally, up to 2% by volume of carbon dioxide (CO₂), carbon monoxide (CO), nitric oxide (NO), and mixtures thereof may be combined with active gas component (N₂O+O₂) or (N₂+O₂).

The inert portion improved shielding gas may be made up of gases and combinations of gases that include Ar and helium.

Adding certain active gases components into an inert gas, e.g., Ar, at low levels (e.g., between 0.5 to 3%) improves wetting during welding and decreases or eliminates some of the defects described above.

More specifically, a gas mixture is provided herein, which consists predominantly of Ar and contains small amounts of active gas components, e.g., N₂O, N₂, and/or O₂.

According to an embodiment of the present invention, two different active gas components are used, each typically in amounts under 1% of the overall mixture. When compared to pure Ar, the addition of two active gases decreases the surface tension of the molten material in the weldment, improves wettability, and provides various benefits, including lowering defectivity and decreasing the roughness of the weldment.

Active gas components (N₂O+O₂) or (N₂+O₂) are added to Ar in order to provide a gas mixture that decreases or eliminates skips and/or holes in welds and improves weld surface roughness in laser conduction welding of aluminum.

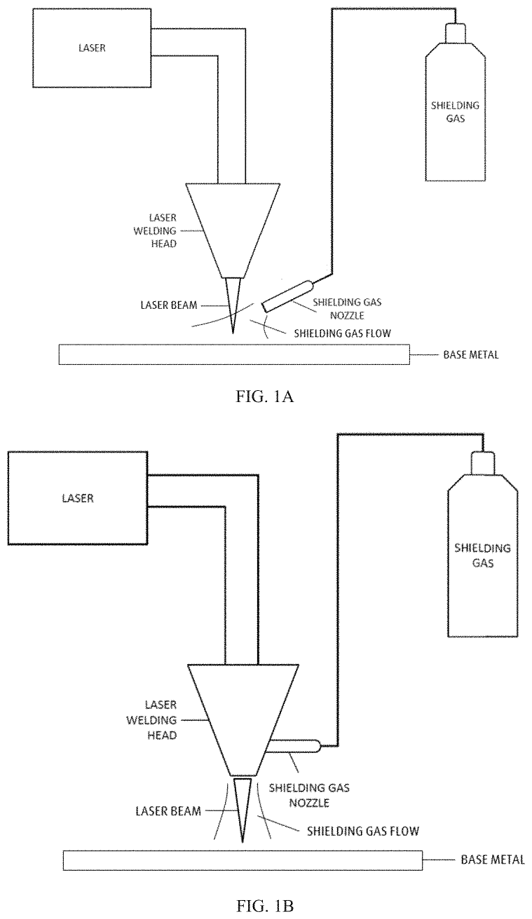

FIGS. 1A and 1B illustrate basic structures of an apparatus for laser welding aluminum, according to embodiments of the present invention.

Referring to FIGS. 1A and 1B, the apparatus includes a laser, e.g., a fiber laser, including a laser welding head. The apparatus also include a shielding gas delivery system that provides the shielding gas, through a shielding gas nozzle, into (FIG. 1B) or adjacent to (FIG. 1A) the laser welding head in order to improve surface appearance of the welds and provide a more stable welding process. More specifically, the active gas components (N₂O+O₂) or (N₂+O₂) react with molten aluminum forming oxides at melt/metal interface, reducing surface tension and improving wetting of the weld bead. There is a mutual effect between the N₂ and O₂ in improving the wetting during the welding. As such, the best results are obtained with mixtures of two active gases in Ar.

The active gases also react with aluminum to form oxides on molten pool surface, yielding enhanced laser absorption and resulting in higher melt temperature, deeper and wider weld and lower melt viscosity and lower surface tension. This improved wettability significantly reduces the discontinuity defects (skips and holes), leading to lower scrap rates.

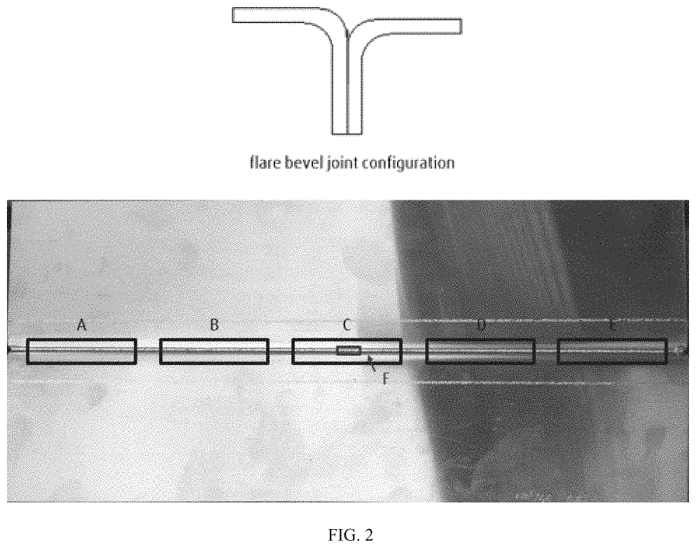

FIG. 2 illustrates a flare bevel joint configuration and an overhead view a weld surface thereof, according to an embodiment of the present invention.

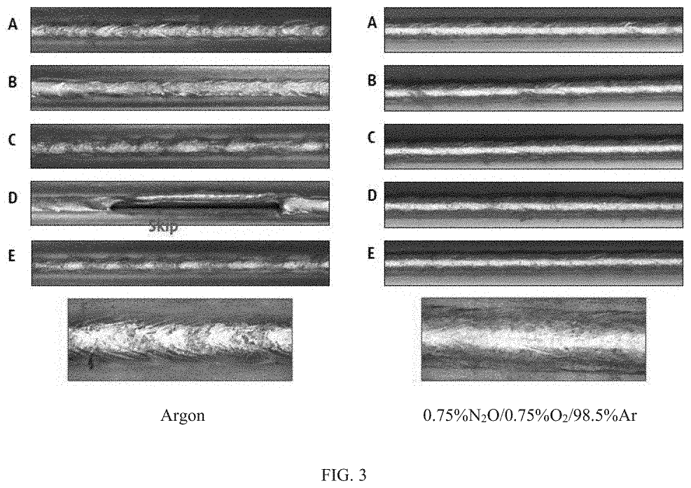

Referring FIG. 2, a gas mixture 0.75% N₂O/0.75% O₂/98.5% Ar is tested for a flare bevel joint configuration, which is a common joint configuration used in automotive production, in a 15-inch length. The results in different segments A, B, C, D, E, and F along the weld, in conjunction with FIGS. 3 to 5, show the gas mixture improving the weld surface quality and reducing the defects (i.e., skips or holes in the weld or a rough weld surface) when compared to a weld using a shielding gas consisting only of Ar.

FIGS. 3 to 6 illustrate comparisons of flare bevel joint welds of different aluminum alloys using a shielding gas consisting only of Ar and a shielding gas mixture of 0.75% N₂O/0.75% O₂/98.5% Ar, according to an embodiment of the present invention. Specifically, each of FIGS. 3 to 6 illustrate comparison images of segments A, B, C, D, E, and F of FIG. 2.

Referring to FIG. 3, the images on the left correspond to weld segments A, B, C, D, E, and F of FIG. 2 made on a flare bevel joint weld of aluminum alloy 6061 using a shielding gas consisting only of Ar. The images on the right correspond to weld segments A, B, C, D, E, and F of FIG. 2 made on a flare bevel joint weld of aluminum alloy 6061 using a shielding gas mixture of 0.75% N₂O/0.75% O₂/98.5% Ar. As can be appreciated from these images, the weld using a shielding gas mixture of 0.75% N₂O/0.75% O₂/98.5% Ar is consistently smoother with fewer defects.

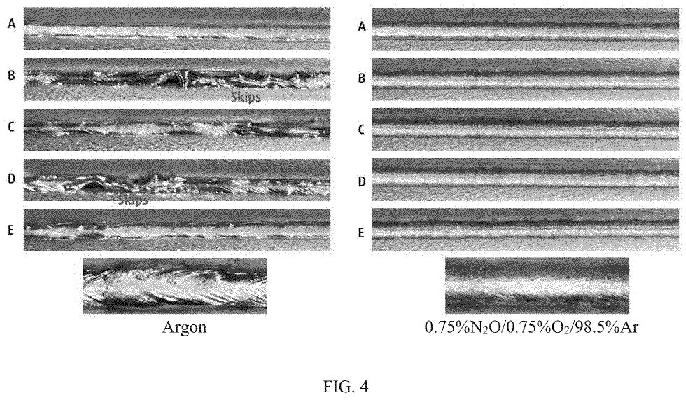

Similarly, referring to FIG. 4, the images on the left correspond to weld segments A, B, C, D, E, and F of FIG. 2 made on a flare bevel joint weld of aluminum alloy 3003 using a shielding gas consisting only of Ar. The images on the right correspond to weld segments A, B, C, D, E, and F of FIG. 2 made on a flare bevel joint weld of aluminum alloy 3003 using a shielding gas mixture of 0.75% N₂O/0.75% O₂/98.5% Ar. As can be appreciated from these images, the weld using a shielding gas mixture of 0.75% N₂O/0.75% O₂/98.5% Ar is again consistently smoother with fewer defects.

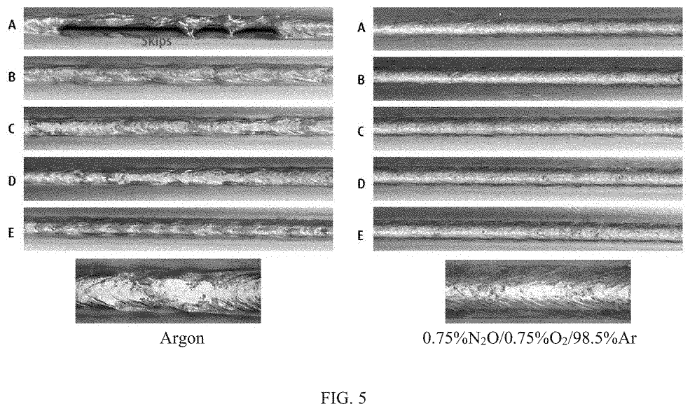

Similarly, referring to FIG. 5, the images on the left correspond to weld segments A, B, C, D, E, and F of FIG. 2 made on a flare bevel joint weld of aluminum alloy 5052 using a shielding gas consisting only of Ar. The images on the right correspond to weld segments A, B, C, D, E, and F of FIG. 2 made on a flare bevel joint weld of aluminum alloy 5052 using a shielding gas mixture of 0.75% N₂O/0.75% O₂/98.5% Ar. As can be appreciated from these images, the weld using a shielding gas mixture of 0.75% N₂O/0.75% O₂/98.5% Ar is again consistently smoother with fewer defects.

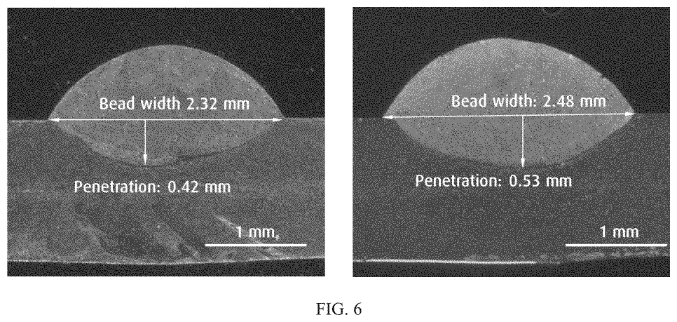

FIG. 6 illustrates a comparison of weld cross-sections using a shielding gas consisting only of Ar and a shielding gas mixture of 0.75% N₂O/0.75% O₂/98.5% Ar, according to an embodiment of the present invention.

Referring to FIG. 6, the image on the left corresponds to a weld cross-section using a shielding gas consisting only of Ar, while the image on the right corresponds to a weld cross-section using a shielding gas mixture of 0.75% N₂O/0.75% O₂/98.5% Ar. As can be appreciated from these images, the weld using a shielding gas mixture of 0.75% N₂O/0.75% O₂/98.5% Ar reduces surface tension at the interface, decreases the contact angle, and improves wetting, resulting in a wider bead width. Additionally, oxides formed by the shielding gas mixture enhance laser absorption. As a result of more laser energy being absorbed, deeper penetration is achieved. Accordingly, use of the shielding gas mixture provides a higher melt temperature, lower melt viscosity, and lower surface tension.

Although FIGS. 2-6 are described above with reference to a shielding gas mixture of 0.75% N₂O/0.75% O₂/98.5% Ar, other mixtures and ratios are available. For example, the N₂O content in the shielding gas may range from 0.5 to 1.0% by volume while the O₂ content in the shielding gas may range from 0.5 to 1.25% by volume.

Further, although FIGS. 2-6 are described above with reference to Al alloys (Al—Cu, Al—Cu—Mg, Al—Mg—Si, Al—Zn—Mg and Al—Zn—Mg—Cu, etc.), the above-described shielding gas mixture may also be advantageous when used in dissimilar welding of Al alloys to other metals, e.g., steel, stainless steel, copper, ideally for laser conduction welding of Al alloys.

Additionally, the above-described shielding gas may be utilized with Stargon Al+air. Stargon Al comprises a mixture of 200 ppm N₂O, 200 ppm O₂, balance Argon in arc welding of Al and is available from Linde Inc., 10 Riverview Drive, Danbury, Conn. 06810.

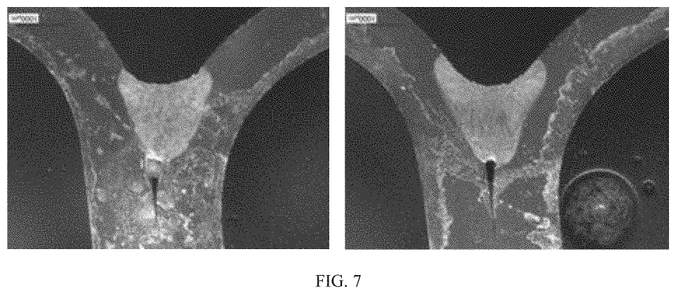

FIG. 7 illustrates a comparison of weld cross-sections using a shielding gas consisting only of Ar and a shielding gas mixture of Ar and (N₂O+O₂) or (N₂+O₂), according to an embodiment of the present invention.

Referring to FIG. 7, the image on the left corresponds to a weld cross-section using a shielding gas consisting only of Ar, while the image on the right corresponds to a weld cross-section using a shielding gas mixture of Ar and (N₂O+O₂) or (N₂+O₂). As can be appreciated from these images, the weld using a shielding gas mixture of Ar and (N₂O+O₂) or (N₂+O₂) provides deeper penetration and wider fusion zone.

As described in the embodiments above, by utilizing a shielding gas mixture of Ar and (N₂O+O₂) or (N₂+O₂), e.g., in a range of 1% to less than 2.5%, a more stable process of fiber laser welding can be performed with fewer defects, smoother surfaces, decreased surface tension, improved wetting, wider bead widths, and deeper penetration.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A shielding gas for laser welding workpieces comprising aluminum or aluminum alloy, the shielding gas comprising:
argon (Ar); and
active gas components in a range of 0.5% to 3% by volume of the shielding gas,
wherein the active gas components include a combination of oxygen (O₂) and at least one of nitrous oxide (N₂O) and nitrogen (N₂).

2. The shielding gas of claim 1, wherein the active gas components are in a range of 1% to 2.5% by volume of the shielding gas.

3. The shielding gas of claim 1, wherein, when the active gas components include the combination of (N₂O+O₂), the N₂O content in the shielding gas ranges from 0.5 to 1.0% by volume, and the O₂ content in the shielding gas ranges from 0.5 to 1.25% by volume.

4. The shielding gas of claim 1, wherein, when the active gas components include the combination of (N₂O+O₂), the N₂O content in the shielding gas is 0.75% by volume, and the O₂ content in the shielding gas is 0.75% by volume.

5. The shielding gas of claim 1, wherein, when the active gas components include the combination of (N₂O+O₂), the N₂O content in the shielding gas is 0.5% by volume.

6. The shielding gas of claim 1, wherein the O₂ content in the shielding gas ranges from 0.1 to 2.9% by volume.

7. The shielding gas of claim 1, wherein the at least one of the N₂O and the N₂ content in the shielding gas ranges from 0.1 to 2.9% by volume.

8. The shielding gas of claim 1, further comprising up to 2% by volume of an additional gas selected from carbon dioxide (CO₂), carbon monoxide (CO), nitric oxide (NO), and mixtures thereof.

9. A method for laser welding workpieces including aluminum or aluminum alloy, the method comprising:
activating the laser for a weld; and
providing a shielding gas including argon (Ar) and active gas components to the weld,
wherein the active gas components are in a range of 0.5% to 3% by volume of the shielding gas, and
wherein the active gas components include a combination of oxygen (O₂) and at least one of nitrous oxide (N₂O) and nitrogen (N₂).

10. The method of claim 9, wherein the laser is a fiber laser wherein the shielding gas is provided into the activated laser or adjacent to the activated laser and the weld.

11. The method of claim 9, wherein, when the active gas components include the combination of (N₂O+O₂), the N₂O content in the shielding gas is 0.75% by volume, and the O₂ content in the shielding gas is 0.75% by volume.

12. The method of claim 9, wherein the active gas components are in a range of 1% to 2.5% by volume of the shielding gas.

13. The method of claim 9, wherein, when the active gas components include the combination of (N₂O+O₂), the N₂O content in the shielding gas ranges from 0.5 to 1.0% by volume, and the O₂ content in the shielding gas ranges from 0.5 to 1.25% by volume.

14. The method of claim 9, wherein, when the active gas components include the combination of (N₂O+O₂), the N₂O content in the shielding gas is 0.5% by volume.

15. The method of claim 9, wherein the O₂ content in the shielding gas ranges from 0.1 to 2.9% by volume.

16. The method of claim 9, wherein the shielding gas further includes up to 2% by volume of an additional gas selected from carbon dioxide (CO₂), carbon monoxide (CO), nitric oxide (NO), and mixtures thereof.

17. An apparatus for laser welding workpieces including aluminum or aluminum alloy, the apparatus comprising:
a laser configured to apply a laser beam to a weld; and
a shielding gas delivery system configured to provide a shielding gas including argon (Ar) and active gas components to the weld,
wherein the active gas components are in a range of 0.5% to 3% by volume of the shielding gas, and
wherein the active gas components include a combination of oxygen (O₂) and at least one of nitrous oxide (N₂O) and nitrogen (N₂).

18. The apparatus of claim 17, wherein the laser is a fiber laser and wherein the shielding gas delivery system is configured to provide the shielding gas into the activated laser or adjacent to the activated laser and the weld.

19. The apparatus of claim 17, wherein, when the active gas components include the combination of (N₂O+O₂), the N₂O content in the shielding gas ranges from 0.5 to 1.0% by volume, and the O₂ content in the shielding gas ranges from 0.5 to 1.25% by volume.
